(19) United States
(12) Patent Application Publication
(10) Pub. No.: US 2005/0084234 A1
(43) Pub. Date: Apr. 21, 2005

(54) Reproducing apparatus and reproducing method

(76) Inventor: Masahito Ejiri, Hamura-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/948,561

(22) Filed: Sep. 24, 2004

(30) Foreign Application Priority Data
Oct. 20, 2003 (JP) 2003-359376

(51) Int. Cl. H04N 5/781

(52) U.S. Cl. 386/46; 386/125

(57) ABSTRACT

A reproducing apparatus has a plurality of input units which input a picture signal, a reproducing unit which selects one input unit from the plurality of input units and reproduces a picture signal from the selected input unit, a storage unit which stores the selected input unit by the reproducing unit in association with predetermined information, and a control unit which, when the user setting of the storage unit is specified, changes an input in order to select such one input unit stored in the storage unit again.

### CROSS-REFERENCE TO RELATED APPLICATIONS

This application is based upon and claims the benefit of priority from prior Japanese Patent Application No. 2003-359376, filed Oct. 20, 2003, the entire contents of which are incorporated herein by reference.

### BACKGROUND OF THE INVENTION

1. Field of the Invention

The present invention relates to an apparatus for reproducing a picture signal, and more particularly, to a reproducing apparatus and a reproducing method for making an adjustment of an input signal or a picture according to registered settings.

2. Description of the Related Art

In recent years, digital picture equipment has been increased in number. For example, there is a reproducing apparatus using a light source lamp such as a liquid crystal projector or a DLP projector. In such a reproducing apparatus such as a liquid crystal projector, it is possible to provide a variety of settings, and such settings can be arbitrarily selected according to usage.

A prior art (Jpn. Pat. Appln. KOKAI Publication No. 2002-116736) discloses a method for changing an image of a liquid crystal display apparatus in which it is possible to change an image adjusting screen for a text screen to an image adjusting screen for motion picture viewing. Therefore, a user can easily obtain an adjustment screen according to usage because there is no need for the user to make fine adjustment of a screen every time.

In the above-described prior art, image adjustment of a liquid crystal screen is made based on the contents registered according to usage. In the case of a reproducing apparatus such as a liquid crystal projector according to the present invention, a number of picture signals are inputted according to a number of signal modes of picture signals. A user who is not familiar with operation may not be able to make a decision as to which input signal should be selected. Further, such a user must provide every time a number of initial settings such as adjustment of a picture signal or a voice signal for the purpose of image adjustment, focusing or zooming upon change of a projector location, or keystone correction, and an operation for reproduction becomes very complicated. In the method according to the prior art, there has been a problem that these settings cannot be easily provided.

### BRIEF SUMMARY OF THE INVENTION

According to one aspect of the present invention, there is provided a reproducing apparatus comprising: a plurality of input units which input a picture signal; a reproducing unit which selects one input unit from the plurality of input units and reproduces a picture signal from the selected input unit; a storage unit which stores the input unit selected by the reproducing unit in association with predetermined information; and a control unit which, when the predetermined information stored in the storage unit is specified, changes an input in order to select the input unit stored in the storage unit again.

### BRIEF DESCRIPTION OF THE SEVERAL VIEWS OF THE DRAWING

FIG. 1 is a block diagram depicting an example of a configuration of a reproducing apparatus according to the present invention;

FIGS. 2A and 2B are schematic views each showing an example of an appearance of the reproducing apparatus according to the invention;

FIG. 3 is an explanatory view illustrating an example of an optical configuration of the reproducing apparatus according to the invention;

FIG. 4 is an explanatory view illustrating an example of a connection terminal of the reproducing apparatus according to the invention;

FIG. 5 is an explanatory view illustrating an example of a remote controller device for use in the reproducing apparatus according to the invention;

FIGS. 6A, 6B and 6C are connection diagrams each showing an example of connection between another device and the reproducing apparatus according to the invention;

FIG. 7 is an explanatory view illustrating an example of a screen showing a user memory list of the reproducing apparatus according to the invention;

FIG. 8 is an explanatory view illustrating another example of a screen showing a user memory list of the reproducing apparatus according to the invention;

FIG. 9 is a flow chart showing an example of a registering operation for user settings of the reproducing apparatus according to the invention;

FIG. 10 is a flow chart showing an example of a utilizing operation for user settings of the reproducing apparatus according to the invention;

FIG. 11 is an explanatory view illustrating an example of a picture adjusting menu list of the reproducing apparatus according to the invention;

FIG. 12 is an explanatory view illustrating an example of a picture adjusting menu list of the reproducing apparatus according to the invention;

FIG. 13 is an explanatory view illustrating an example of a voice adjusting menu list of the reproducing apparatus according to the invention;

FIGS. 14A and 14B are explanatory views illustrating an example of an initial setting menu list of the reproducing apparatus according to the invention;

FIG. 15 is an explanatory view illustrating an example of a state display menu list of the reproducing apparatus according to the invention;

FIG. 16 is an explanatory view illustrating an example of a plurality of projection methods of the reproducing apparatus according to the invention;

FIGS. 17A, 17B and 17C are illustrative views each showing an example of keystone correction of the reproducing apparatus according to the invention;

FIG. 18 is an explanatory view illustrating a relationship between an input signal and a projection screen of the reproducing apparatus according to the invention; and

FIG. 19 is a flow chart showing an example of an icon setting operation for user registration of the reproducing apparatus according to the invention.

### DETAILED DESCRIPTION OF THE INVENTION

Hereinafter, embodiments of a reproducing apparatus according to the present invention will be described in detail with reference to the accompanying drawings. In the reproducing apparatus according to the invention, a variety of complicated setting processes in a projector which can be utilized in response to a variety of picture sources are stored as arbitrarily provided reproduction settings and/or user settings (memory data), and the stored settings are momentarily called during reproduction, thereby making it possible to reproduce desired picture sources in the best setting state. The reproducing apparatus having a reproduction setting function according to the invention is directed to an apparatus for reproducing a picture signal. This reproducing apparatus includes a television, a video recorder or a disk recorder. In addition, the reproducing apparatus covers a variety of devices such as a projection device such as a projector or a display device having a liquid crystal screen, a plasma screen or the like. In the following, in particular, a description will be given in detail with reference to the accompanying drawings by way of example of a display device which is a projector device.

<Reproducing Apparatus According to the Present Invention>

(Configuration)

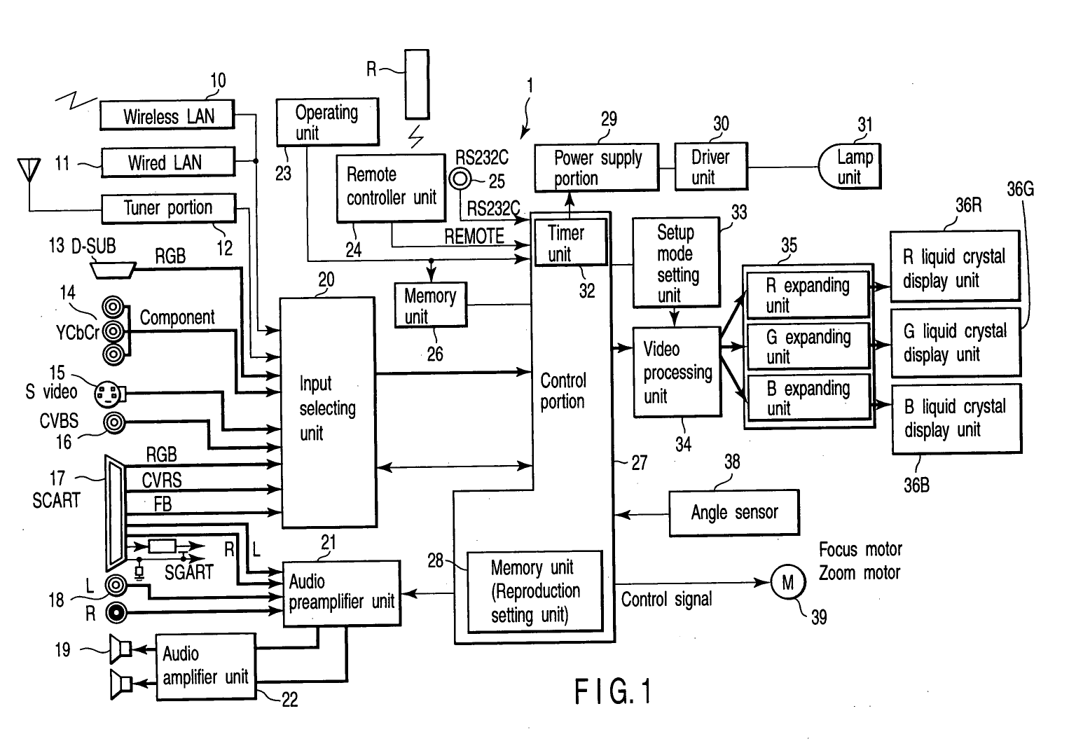

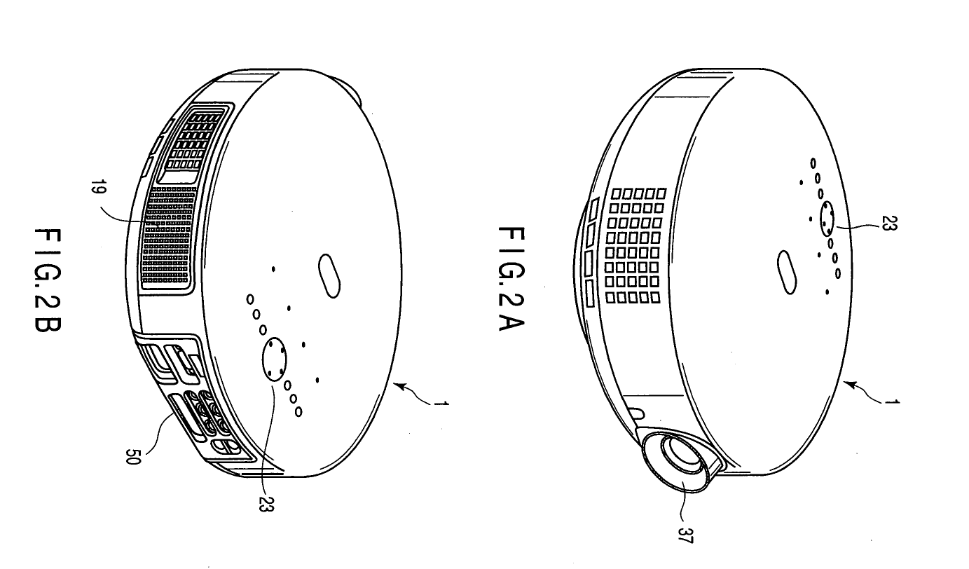

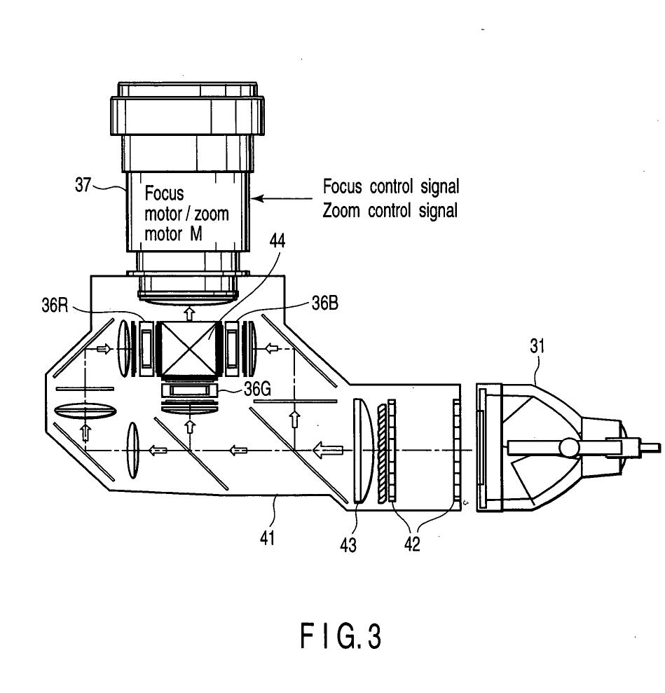

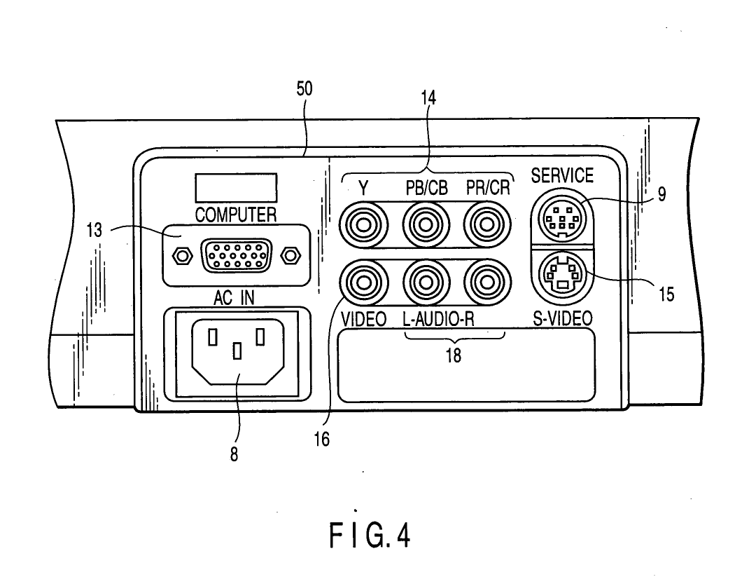

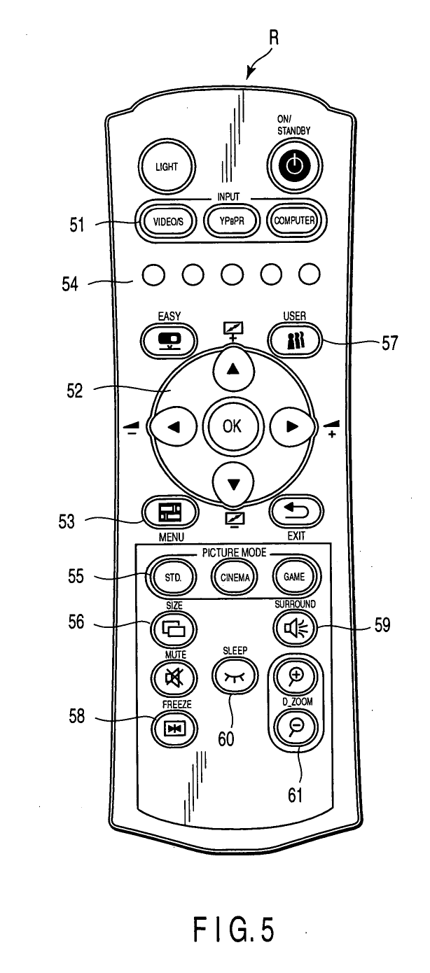

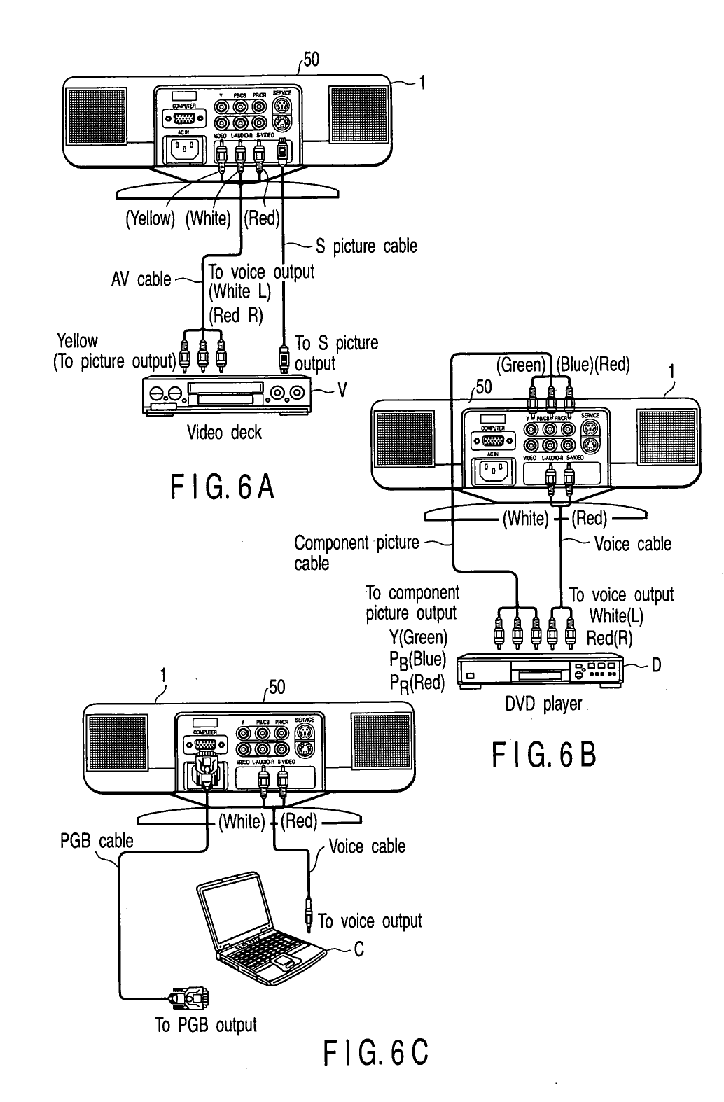

FIG. 1 is a block diagram depicting an example of a configuration of a reproducing apparatus according to the present invention. FIGS. 2A and 2B are schematic views each showing an example of an appearance of the reproducing apparatus according to the invention. FIG. 3 is an explanatory view illustrating an example of an optical configuration of the reproducing apparatus according to the invention. FIG. 4 is an explanatory view illustrating an example of a connection terminal of the reproducing apparatus according to the invention. FIG. 5 is an explanatory view illustrating an example of a remote controller device for use in the reproducing apparatus according to the invention. FIGS. 6A, 6B and 6C are connection diagrams each showing an example of connection between another device and the reproducing apparatus according to the invention.

In FIGS. 1, 2A, 2B and 4, a reproducing apparatus 1 such as a projector apparatus according to the invention comprises, by way of example: a wireless LAN 10 carried out via wireless communication in house; a wired LAN 11; a tuner unit 12 for supplying a reception signal upon the receipt of a broadcast signal from an antenna; a D-SUB terminal 13 having a computer or the like mainly connected thereto, the terminal being indicated by an input/output terminal 51; a YCbCr terminal having a business use VTR (Video Tape Recorder), a BS digital tuner, a DVD player or the like mainly often connected thereto; an S video terminal 15 for use in a VTR, television or the like; a CVBS terminal 16 which is a composite signal; and an SCART terminal 17 which is mainly a standard terminal of an European picture signal. These constituent elements are connected to at least an input selecting unit 20. Further, a voice signal and a voice terminal 18 of the SCART terminal 17 are connected to an audio preamplifier unit 21. At the audio preamplifier unit 21, an input signal is mainly subjected to processing of a volume, sound quality and acoustic effect and the like, and the processed signal is supplied to an audio amplifier unit 22.

Furthermore, at the input selecting unit 20, a selected and picture-converted RGB signal is supplied to a control unit 27. In addition, operating processes of the input selecting unit 20 and audio amplifier unit 21 are controlled according to a control signal from the control unit 27.

Moreover, the reproducing apparatus 1 has: an operating unit 23 such as a power switch or an operating switch provided at a main body thereof; a remote controller unit 24 for carrying out processing for communication with a remote controller R shown in FIG. 5; and an RS232C terminal 25 and a memory unit 26 for capturing a control signal. These elements are connected to the control unit 27, respectively. In addition, the control unit 27 has: a memory unit 28 for storing reproduction setting information (user setting information) which is a feature of the present invention described later; and a timer unit 32. Further, an angle sensor 38 for use in keystone connection or the like described later, the angle sensor detecting an angle of the reproducing apparatus 1, and a focus motor or zoom motor 39 incorporated in a lens unit 37 are connected.

Further, this control unit has: a setup mode setting unit 33 for setting a variety of setting modes described later upon the receipt of an output of the control unit 27; a video processing unit 34 for applying picture processing upon the receipt of this output and a picture signal from the control unit 27; an expanding unit 35 for expanding the picture signal processed as a picture by the video processing unit 34 for each of an R signal, a G signal, and a B signal; and an R liquid crystal display unit 36R, a G liquid crystal display unit 36G, and a B liquid crystal display unit 36B for displaying an image on a liquid crystal display screen or the like upon the receipt of a liquid crystal display drive current from the expanding unit.

The reproducing apparatus 1 also has a power supply portion 29. From the power supply portion 29, a drive current of a desired output rate is supplied to a lamp unit 31. At the lamp unit 31, projected projector light beams reach the liquid crystal display units 36R, 36G, and 36B, respectively, and then, are transmitted. The transmitted light beams are projected as projected light beams including a picture on a screen or the like (not shown).

Further, as the optical configuration of the reproducing apparatus 1, in FIG. 3, a projector lamp 35 is allocated in the vicinity of an optical unit 41. The emission light beams emitted from the optical unit 41 pass through multiple lenses 42 and a convex lens 43 provided adjacent to the multiple lenses. The light beams pass through or reflect a transmission mirror and transmit the liquid crystal display panels 36R, 36G, and 36B, respectively. In this manner, the emission light from the projector lamp 31 is emitted from a projection lens 37 in a state in which a picture is superimposed, and the picture is focused on a screen or the like (not shown) to which the projection light beams are projected. The projection lens 37 incorporates a focus motor or zoom motor M; control signals respectively are supplied from the control unit 27; and proper focus control and zoom control are carried out.

In FIG. 5, the remote controller R for use in the reproducing apparatus 1 according to the invention has: an input switch button 51 for making a switch of an input signal; a selector/OK button 52 for making selection, determination and the like by making menu selection, adjustment and the like; a menu button 53 for displaying a menu; a setting switch 54 for registering and calling reproduction settings (user settings) described later on one to one basis, according to the present invention; a picture mode button 55 for making a picture mode selection; a size button 56 for making a screen size selection; a user button 57 for calling the registered user settings; a freeze button 58 for freezing a picture; a surround button 59 having a surround effect mode selection; a sleep button 60 for temporarily sleeping a picture and a voice; and a zoom button 61 for zooming a picture, respectively.

In FIG. 6A, the reproducing apparatus 1 according to the present invention and a video deck V which is an external input device are connected to each other by using the composite terminal 16, the audio terminal 18, and the S video terminal 15. In FIG. 6B, the reproducing apparatus 1 according to the invention and a DVD player D which is an external input device are connected to each other by using the YCbCr terminal 14. In FIG. 6C, the reproducing apparatus 1 according to the invention and a personal computer C which is an external input device are connected to each other by using the D-SUB terminal 13.

(Basic Operation)

Now, an operation of the above-described reproducing apparatus 1 will be described below in detail with reference to the accompanying drawings. First, the reproducing apparatus 1 is started up according to an operation for turning ON power of the operating unit 23 and remote controller R, and a picture signal specified by the input switch button 51 or the like is selected by the input selecting unit 20. That is, for example, when “YPbPr” is selected by operation of the input switch button 51 such as the remote controller R, a component picture signal from the external DVD player D is selected via the YPbPr terminal 14 by means of the input selecting unit 20. Then, with respect to the component picture signal, a signal type is determined by the input selecting unit 20; image conversion processing according to the associated signal type is carried out; and an RGB signal is outputted.

In the case of signal acquisition from a network via the wireless LAN 10 or wired LAN 11 without being limited to the component signal of the YPbPr terminal, in the case of a picture signal or that acquired from the tuner unit 12, or in the case of a picture signal acquired from the S video terminal 15, a picture signal acquired from the CVBS terminal 16 which is a composite signal or a picture acquired from the SCART terminal 17 is specified by the operating units 23, 24, and type of the picture signal is determined. According to the determination, an operation for converting an image to the RGB signal is made similarly.

The RGB signal supplied from the input selecting unit 20 is supplied to the control unit 27. On the other hand, by means of the operating unit 23 and remote control unit 24, for example, a control signal is supplied to the video processing unit 34 by the setup mode setting unit 33 according to the picture mode or picture size specified by the size button 56. At the video processing unit 34, according to a provided control signal, image conversion processing is applied to the RGB signal supplied from the control unit 27, and the processed signal is changed to a requested picture mode or a picture size.

Further, if an operation of the picture mode button 55 for making a picture mode selection is “CINEMA”, image processing is applied to an RGB signal so as to enter a picture mode according to that operation, and, for example, the processed signal is converted to a picture signal for cinema.

The converted picture signal is supplied from the video processing unit 34 to the expending portion 35. The supplied signal is expanded for each of the R signal, G signal, and B signal. The expanded signals are displayed as pictures, respectively, on a liquid crystal display screen of the R liquid crystal display unit 36R, G liquid crystal display unit 36G, and B liquid crystal display unit 36B, respectively. On the other hand, at a driver unit 30 of a lamp to which power is supplied from the power supply portion 29, for example, a drive current is supplied to the lamp unit 31 upon the receipt of control such as a 100% output or a 50% output. The lamp unit 31 emits projection light beams according to this drive current. As shown in FIG. 3, the projection light beams pass through the multiple lenses 42 and the convex lens 43 provided adjacent to the multiple lenses. Then, the light beams pass through a transmission mirror or is reflected to this mirror, and transmit the liquid crystal display panels 36R, 36G, and 36B, respectively. In this manner, the projection light beams from the projection lamp 31 are emitted from the projection lens 37 in a state in which a picture is superimposed. The picture is focused on a screen (not shown) or the like to which the projection light beams are projected.

Furthermore, at the projection lens 37, the control signal generated at the control unit 27 is supplied to the focus motor M or zoom motor M according to an operation of the operating unit 23 and the remote controller unit 24 or according to the zoom button 61 or the like. Then, focus control or zoom control proper to projection light beams is provided.

As has been described above, in the reproducing apparatus 1 according to the invention, for example, in the case where a user attempts to view a DVD cinema by a DVD player D, a variety of processing operations must be carried out in a default setting manner or manually every time, the processing operations including: an input signal switch process (in general, the YCbCr terminal is often used); selection of a picture mode (in general, a CINEMA mode is often selected); voice control (in general, DVD voice is often set to high because it is usually set to low); sound quality control (a sound is preferred in cinema); and initial settings in the case where the main body is set up again (selections of zoom correction, focus correction, keystone correction, standard or ceiling suspension, front side or rear side, and the like). In addition, many of these adjustments are reflected to user's individual preference, and it becomes a complicated and difficult work to reproduce all of these adjustments every time. Therefore, it is preferable to easily carry out this work by registration and utilization of the user settings and/or reproduction settings according to the invention described later.

(Operation for Registering User Settings and/or Reproduction Settings)

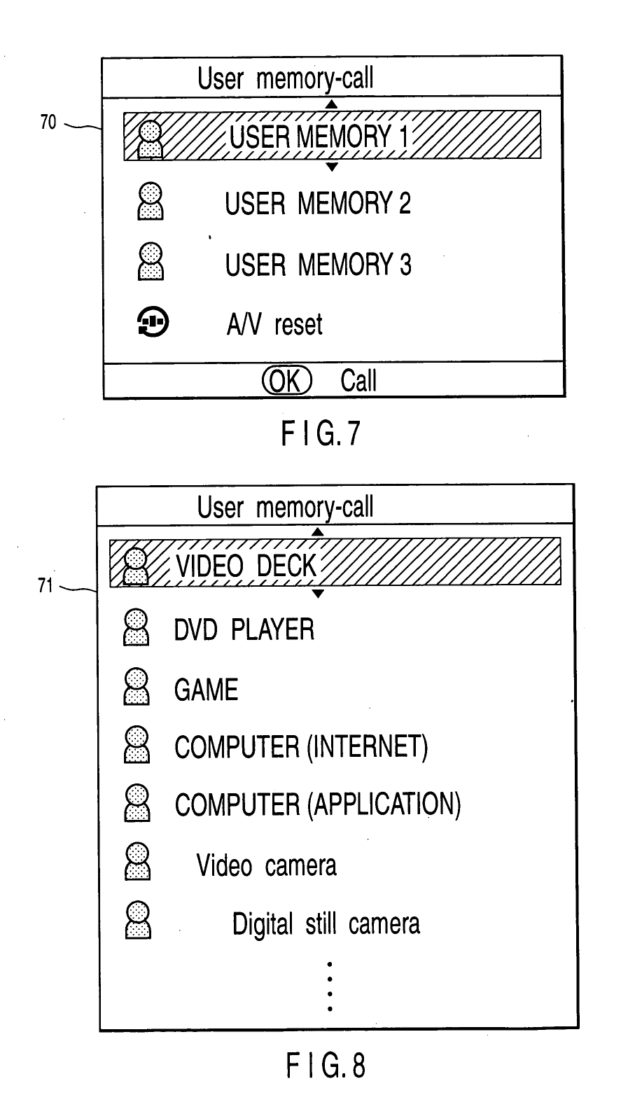

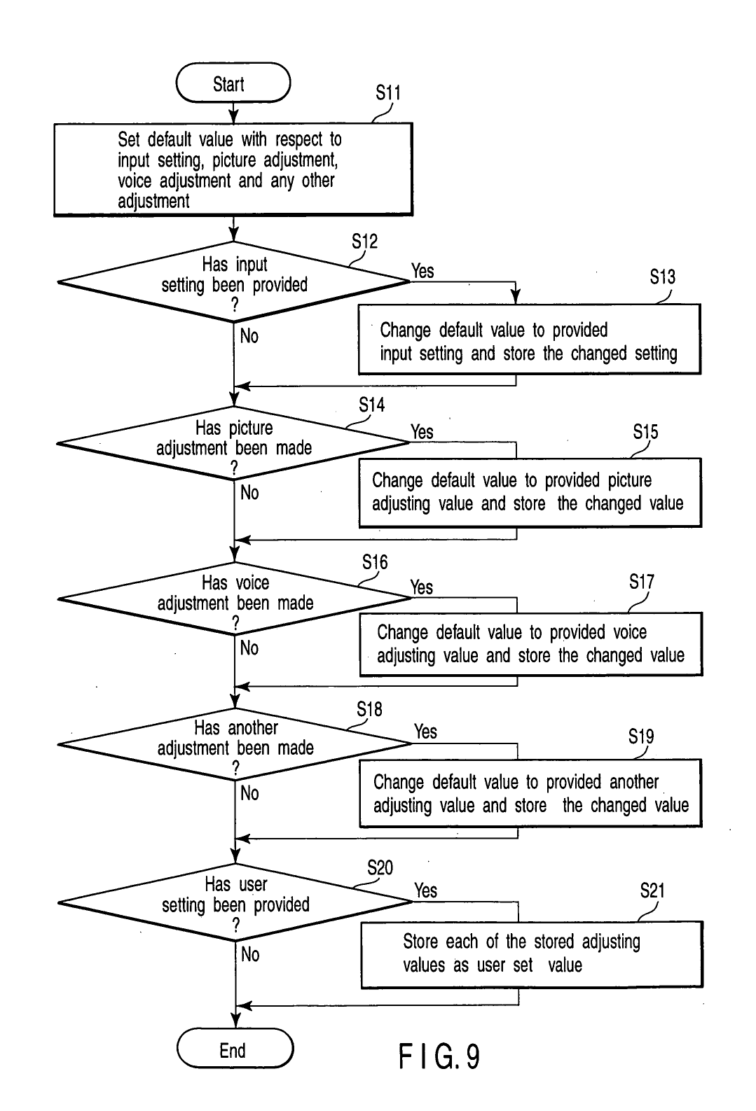

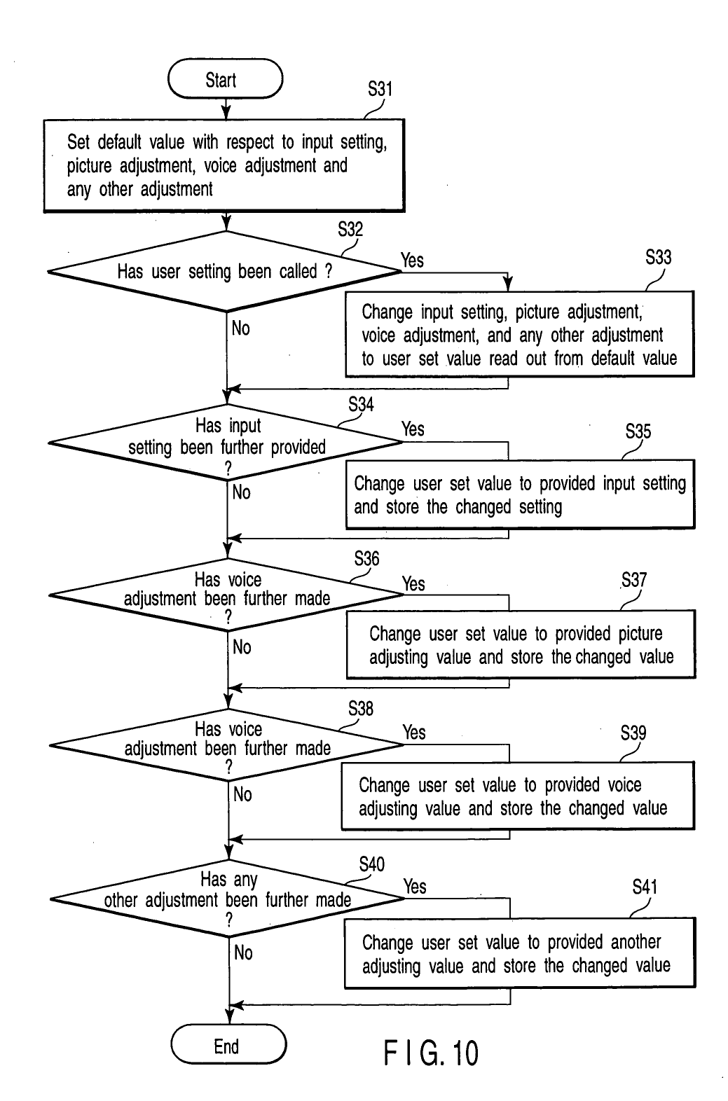

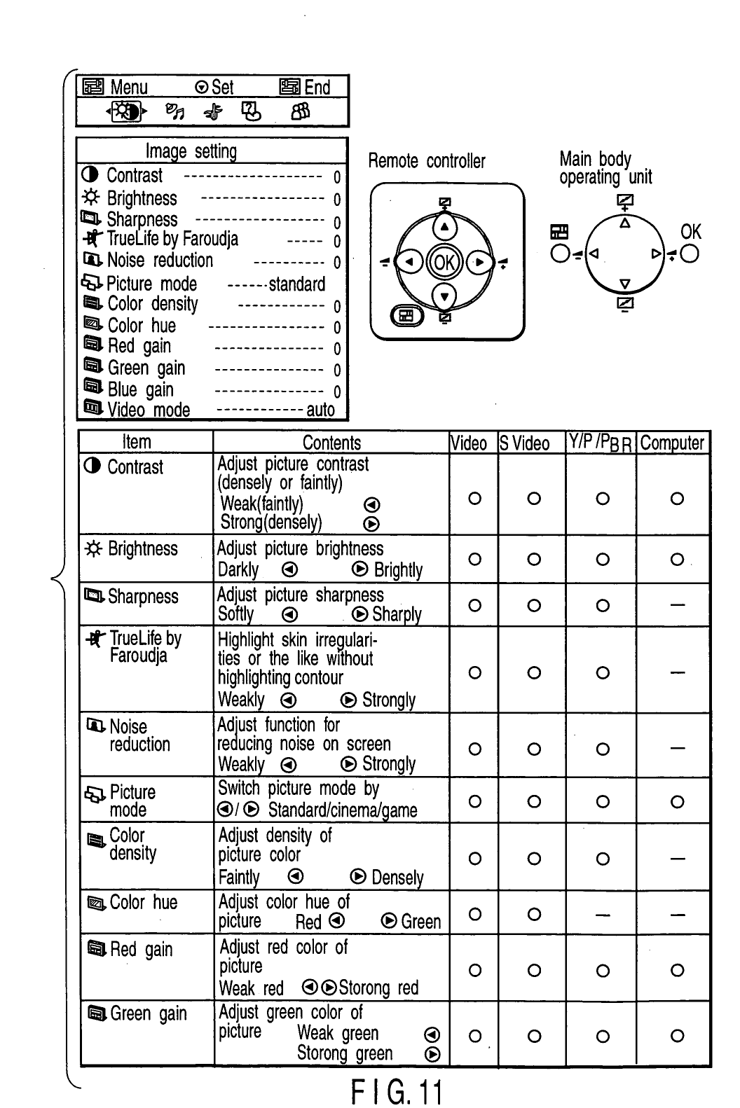

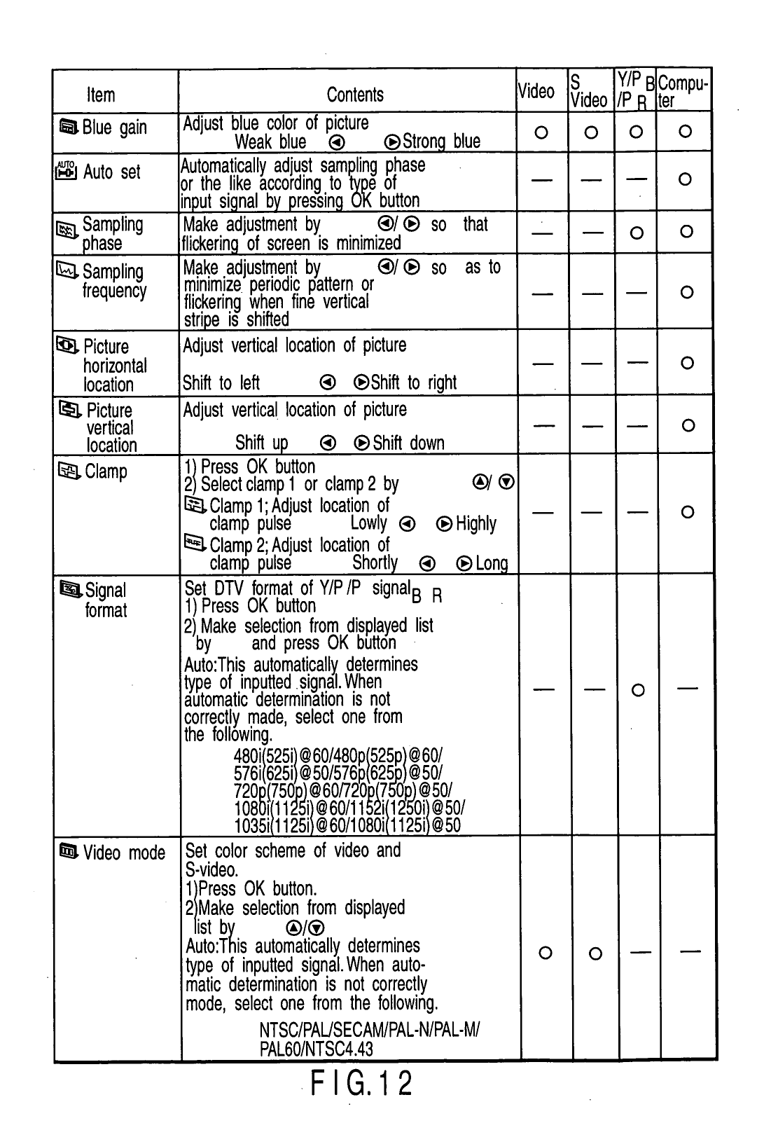

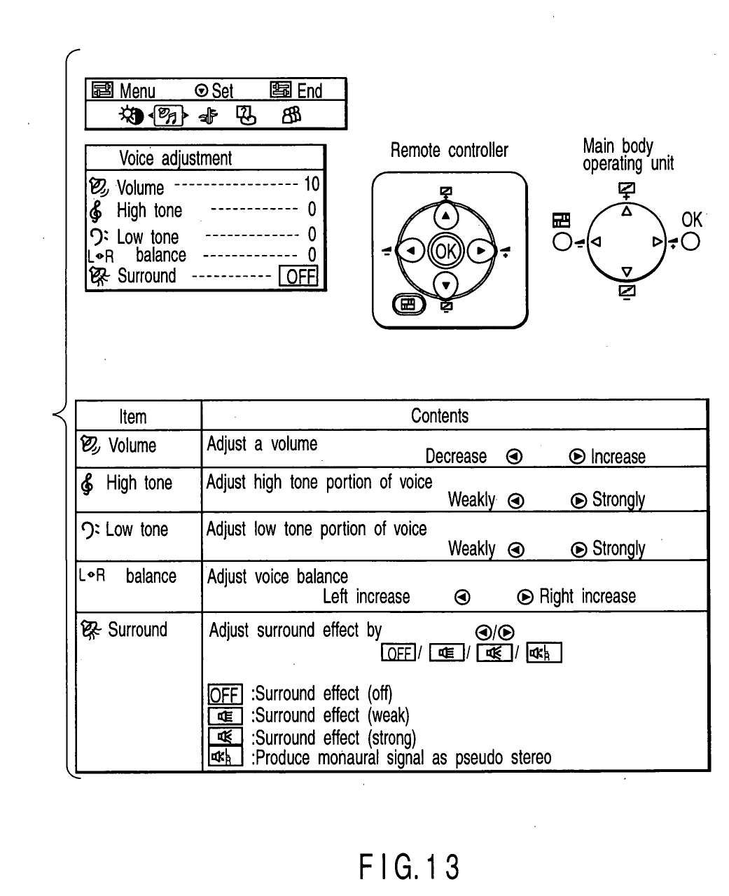

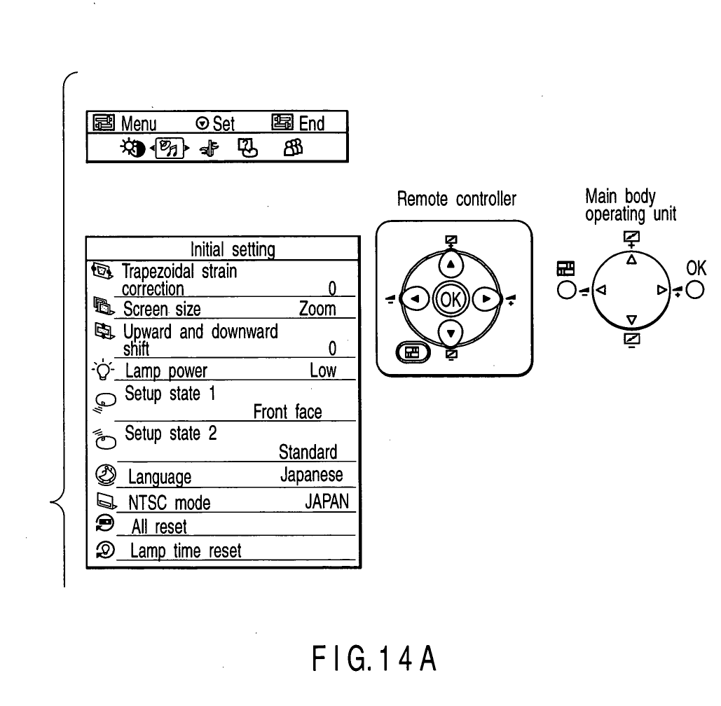

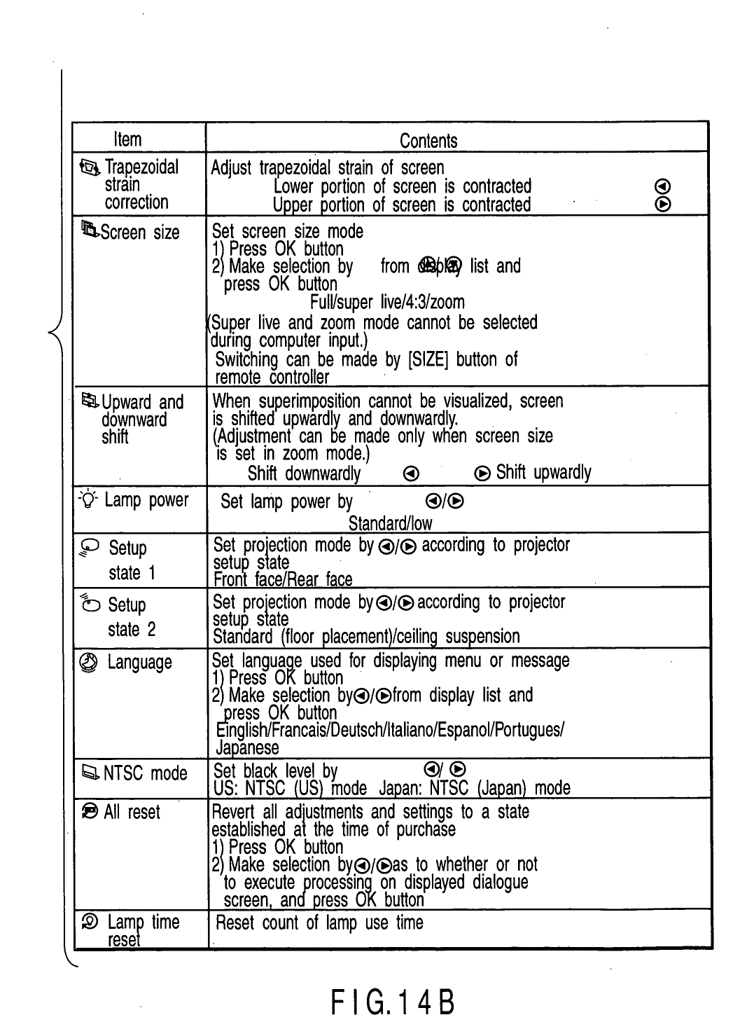

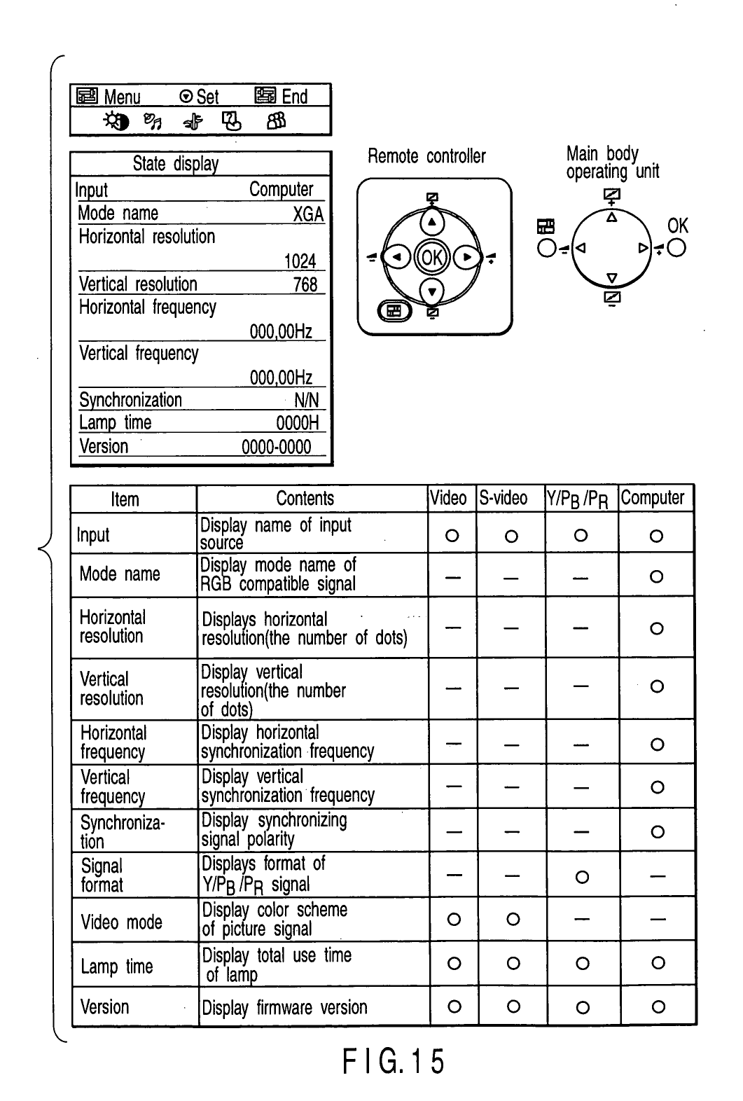

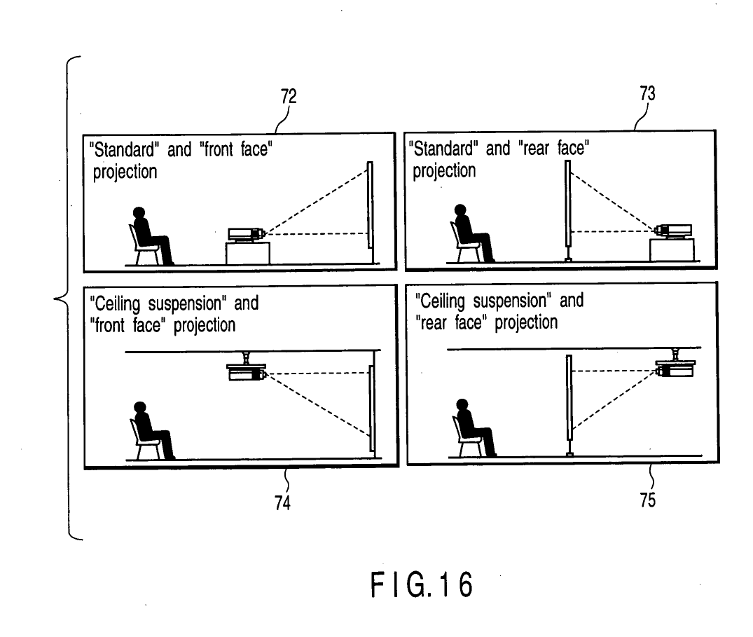

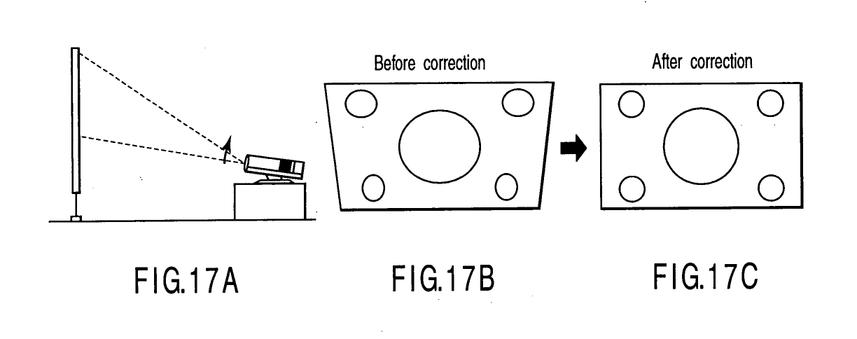

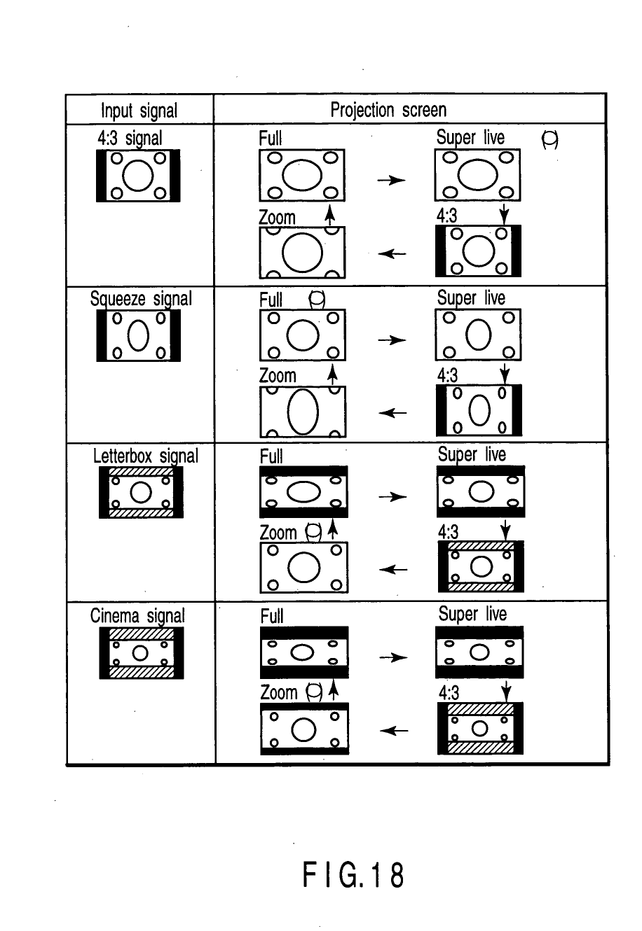

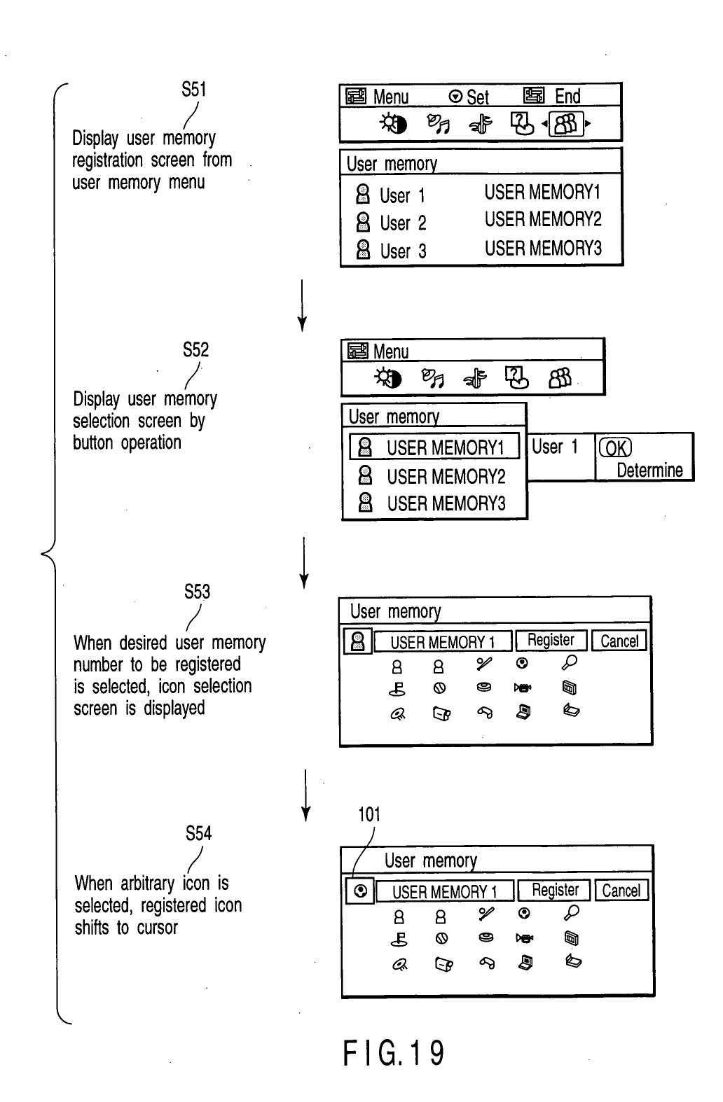

In accordance with the user settings or reproduction settings of the reproduction settings according to the invention, a variety of settings described above are stored in a memory or the like, and during reproduction, these settings are called, and are easily provided. FIG. 7 is an explanatory view illustrating an example of a screen showing a user memory list of the reproducing apparatus according to the invention. FIG. 8 is an explanatory view illustrating another example of a screen showing a user memory list of the reproducing apparatus according to the invention. FIG. 9 is a flow chart showing an example of an operation for registering user settings of the reproducing apparatus according to the invention. FIG. 10 is a flow chart showing an example of an operation for utilizing user settings of the reproducing apparatus according to the invention. FIG. 11 is an explanatory view illustrating an example of a picture adjusting menu list of the reproducing apparatus according to the invention. FIG. 12 is an explanatory view illustrating an example of a picture adjusting menu list of the reproducing apparatus according to the invention. FIG. 13 is an explanatory view illustrating an example of a voice adjusting menu list of the reproducing apparatus according to the invention. FIGS. 14A and 14B are explanatory views illustrating an example of an initial setting menu list of the reproducing apparatus according to the invention. FIG. 15 is an explanatory view illustrating an example of a state display menu list of the reproducing apparatus according to the invention. FIG. 16 is an explanatory view illustrating an example of a plurality of projection methods of the reproducing apparatus according to the invention. FIGS. 17A, 17B and 17C are illustrative views each showing an example of keystone correction of the reproducing apparatus according to the invention. FIG. 18 is an explanatory view illustrating a relationship between an input signal and a projection screen of the reproducing apparatus according to the invention. FIG. 19 is a flow chart showing an example of an icon setting operation for user registration of the reproducing apparatus according to the invention.

In the user setting or reproduction setting of the reproducing apparatus according to the invention, on a screen for calling a user memory on a menu screen, as shown in FIG. 7, for example, setting information is stored as information on three user memories. Alternatively, as shown in FIG. 8, a memory according to a plurality of reproduction uses is provided such as “VIDEO DECK”, “DVD PLAYER”, “GAME”, “COMPUTER (INTERNET)”, “COMPUTER (APPLICATION)”, “VIDEO CAMERA”, or “STILL CAMERA”, and setting information according to the uses is registered.

That is, in a registering process for user settings or reproduction settings, as shown in the flow chart of FIG. 9, when the reproducing apparatus 1 is started up according to an operation for turning ON the power of the operating unit 23 or remote controller R, a default value is assigned (S11) with respect to input setting, picture adjustment, voice adjustment, or any other adjustment based on information stored in the memory unit 28 or the like, by the working of the control unit 27.

Next, it is asked as to whether or not input setting is newly provided (S12). If it is, a default value is changed to a provided input setting, and the changed setting is stored in the memory unit 28 or the like (S13).

The input setting used here is assigned from a plurality of input terminals, as described above.

The cases of the input setting generally include:

a case of defining a general television, a video camera and the like as an input at the composite terminal 16;

a case of defining a signal of slightly high image quality priority such as VTR or DVD at the S video terminal (S terminal using Y/C signal) as an input;

a case of defining a high image quality signal such as a digital BS tuner (Y/Pb/Pr) or DVD (Y/Cb/Cr) as an input at the component input terminal 14 (Y/Pb/Pr or Y/Cb/Cr);

a case of inputting a picture and a voice at the SCART terminal 17 (standard input terminal in Europe);

a case of defining an output from a personal computer as an input at the D-SUB terminal 13 (mainly for personal computer);

a case of defining a calligraphic picture camera picture which is provided as standard or which can be mounted as an input in a camera input (calligraphic picture camera for projector) (Toshiba projector); and

a case of displaying a JPEG picture by a PC card input of the wireless LAN 10 or wired LAN 11.

Next, it is asked as to whether or not picture adjustment is newly made (S14). If it is, a default value is changed to a provided picture adjustment value, and the changed value is stored in the memory unit 28 or the like (S15).

Picture adjustment denotes processing of picture signal of a RGB signal caused by the video processing unit 34 of FIG. 1. This processing includes the following:
Contrast: Contrast of brightness (whether a difference in white and black ratio is increased or decreased)
Brightness: Absolute value of brightness (whether a black level is brightened or darkened)
Color: Color density (degree of color density)
Tint: Hue (from green to purple)
Sharpness: Correction of contour of picture (hard or soft)
Red level: Only red color is adjusted.
Green level: Only green color is adjusted.
Blue level: Only blue color is adjusted.
Picture mode: Change of color taste (location of degree of color coordinate at color temperature) can be selected or adjusted (such as standard, cinema, or game)
Screen size: Full (display on an entire panel); 3:4 (standard size screen), 9:16 (landscape mode screen), zoom (partially zoomed screen) and the like are available depending on display mode.

Furthermore, the cases shown in FIGS. 11 and 12 are provided as detailed examples of other picture adjustment. Here, items such as TrueLife By Faroudja, noise reduction, auto set, sampling phase, sampling frequency, picture horizontal location, picture vertical location, clamp, and signal format are additionally provided. Association with a picture signal, an S picture signal, a YPbPr signal, and a computer signal is shown, and further, a relation with a remote computer or a main body operating unit is shown.

Next, it is asked as to whether voice adjustment is newly made (S16). If it is, a default value is changed to a provided voice adjusting value, and the changed value is stored in the memory unit 28 or the like (S17).

As shown in FIG. 13, the voice adjustment used here includes the following:
Volume: Level of sound
High tone: Component at which a high tone is generated
Low tone: Component at which a low tone is generated
Balance: Difference between left and right sound levels
Surround: Sound quality effect considering signal such as echo component or multiple channels. An example of a relationship between a remote controller and a main body operating unit is shown.

Further, it is asked as to whether or not another adjustment has been made (S18). If it is, a default value is changed to another provided adjusting value, and the changed value is stored in the memory unit 28 or the like (S19).

Another adjustment used here denotes, for example, as shown in FIGS. 14A and 14B, trapezoidal strain correction, that is, keystone correction. As shown in FIG. 17A, such adjustment denotes processing for, when a cinema image is produced, correcting a screen showing a trapezoid before corrected, of FIG. 17B, to a screen showing an essential rectangle of FIG. 17C.
Screen size: A screen size mode is set. As shown in FIG. 18, in the case where an input signal is a 4:3 signal, a squeeze signal, a letter box signal, or a cinema signal, a full screen, a super live screen, a 4:3 screen, a zoom screen or the like is assigned, respectively. For example, when the 4:3 signal is inputted here, a projection screen is produced as a zoom. Alternatively, when the squeeze signal is inputted, the projection screen provides setting such as super live. In addition, it is preferable that a zoom value be set, and further, a focus value be set in order to determine a screen size.
Vertical shift: A shift quantity is changed so as to visualize a superimposition or the like.
Lamp power: A lamp brightness is switched, and standard and low modes are available.
Setup state 1: Frontal view or rear view is determined, and four cases of FIG. 16 are specified.
Setup state 2: Standard or ceiling suspension is determined, and four cases of FIG. 16 are specified.
Language: Screen language such as Japanese or English is selected.
NTSC mode: A black level is set.
Reset: All adjustments are reset at the time of purchase.
Lamp time reset: A lamp use time is reset.

Further, it is preferable that the following items be used.
No-signal power OFF: No predetermined time signal is generated, and power is automatically turned OFF.
Time OFF: Power is forcibly turned OFF after a predetermined time interval has elapsed (this item is proper for time limitation such as game).

Here, by referring to a menu, as shown in FIG. 15, it becomes possible to display a state of a reproducing apparatus.

After an adjusting value different from a default value has been thus assigned by the user operation or the like, the user memory registration screen is called by the menu button 53 of the remote controller R in order to associate one user setting to these set values, and the user settings are provided (S20). Here, as an example, all the setting information at the time when the user settings have been provided are stored in the memory unit. However, it is preferable that these items of setting information be stored after arbitrarily selected by the user, and the stored information be reproduced as described later.

Here, in the illustrative view of FIG. 19, the user memory registration screen is displayed (S51), and the user memory selection screen is displayed by a button operation (S52). When a desired user memory number is selected to be registered, the corresponding icon selection screen is displayed (S53). When an arbitrary icon, namely, when a succor ball icon is selected, the selected icon moves to a cursor. Then, the user memory 1 registers a variety of current adjusting values in the memory unit 28 or the like together with the succor ball icon (S54).

Apart from user settings registered like “user memory 1”, as shown in FIG. 8, a target for reproduction is inputted in accordance with the user operation using characters (or by selecting an option provided in a memory or the like in advance), thereby making it possible to register reproduction settings. Like titles “VIDEO DECK” or “DVD PLAYER”, “GAME”, and “COMPUTER (INTERNET)”, it is preferable that these titles be registered in the memory unit 28 or the like in association with a variety of adjusting values. By doing this, when a video deck is reproduced instead of mere registration of set values for each user, an intuitive operation such as calling this memory can be easily made.

It is preferable that the provided user settings or reproduction settings be provided on one to one basis in the setting switch 54 of the remote controller R of FIG. 5, for example, (or a switch of the main body operating unit 23). That is, a first user setting is stored in the memory unit 28 so as to be provided in association with a first setting switch 54. In this manner, it is possible for the user to utilize user settings or reproduction settings more intuitively.

(Operation for Utilizing User Settings and/or Reproduction Settings)

Now, a utilizing operation for calling the thus provided user settings and/or reproduction settings and providing a number of set values momentarily will be described in detail with reference to the flow chart of FIG. 10.

That is, in a utilizing operation for user settings or reproduction settings, as shown in the flow chart of FIG. 10, when the reproducing apparatus 1 is first started up according to an operation for turning ON the power of the operating unit 23 or remote control R, a default value is assigned with respect to input settings, picture adjustment, voice adjustment, and any other adjustment based on information stored in the memory unit 28 or the like by the working of the control unit 27 (S11).

Now, the user button 57 is pressed by the user's operation of the remote controller or the like, and a plurality of user settings as shown in FIG. 7 are displayed on the operating screen. Alternatively, when a plurality of reproduction settings as shown in FIG. 8 are displayed, and then, any one setting is selected and called (S32), the set values stored in the memory 28 is read out, and concurrently, an adjustment value is changed from the previous default value to the set values of the input settings, picture adjustment, voice adjustment, and any other adjustment (S33). In this manner, the user can achieve in batch the previously registered optimal values with respect to the input settings, picture adjustment, voice adjustment, and any other adjustment for viewing a DVD, for example.

Then, in the case where input settings, picture adjustment, voice adjustment, and any other adjustment have been made (S34, S36, S38, S40), the set value according the user setting is stored to be changed to a new value every time (S33, S35, S37, S39, S41). Then, it is possible to newly re-register user settings and/or reproduction settings in accordance with the above-described procedures of FIG. 19.

As described above, with a function for the user settings and/or reproduction settings of the reproducing apparatus according to the invention, the conditions desired by the user are stored and reproduced in batch with respect to the input settings, picture adjustment, voice adjustment, and any other adjustment. In this manner, the user's complicated setting operation which must be made every time is eliminated, thereby making it possible to always provide best performance of the reproducing apparatus by a very easy operation. In particular, in the case where a plurality of users carry out reproduction processing at home with respect to a plurality of picture sources in a plurality of setting locations, its operation and advantageous effect are great. That is, for example, after the setting locations of the reproducing apparatus have been determined at four rooms, when the above-described setup conditions (such as zoom control, focus control, and keystone control) are registered in each user memory, there is no need for carrying out setup and adjustment every time. If only calling the set value of the memory such as “room 1” or “room 2”, it becomes possible to immediately restore an adjusted value in an optimal state suitable to its setting location of its room, and comfortable use is enabled for a plurality of sources of a plurality of users.

Although examples of the user settings and reproduction settings have been shown in the above description, the user can freely set indicator information stored in the memory unit without being limited to these examples. For example, it is possible to input characters, thereby freely setting a nickname for specifying a user of the reproducing apparatus, a title such as “Japanese room on second floor” for providing settings of the reproducing apparatus at the above-described room or a case of usage such as “live concert specification”.

As has been described above in detail, in the above-described reproducing apparatus, for example, predetermined information (reproduction settings or user settings) indicating reproducing sources such as video deck, DVD player, game, or computer is provided, and concurrently, a variety of conditions such as input conditions, for example, are set. During reproduction, for example, in the case of carrying out DVD reproduction, by calling reproduction setting of “DVD PLAYER”, for example, a picture signal from the YPBPR terminal is selected from a number of picture signals connected to the reproducing apparatus main body. In this manner, the user acquires the picture signal from the DVD player immediately via the YPBPR terminal, for example, by an intuitive operation of selecting reproduction setting of “DVD PLAYER” in order to reproduce the DVD. That is, conventionally, there has been a need for the DVD player to track a memory as to whether or not the YPBPR terminal has been utilized or there has been a need for doing a wiring check work or the like.

According to the present invention, an input signal according to usage can be acquired very easily by setting the above-described input conditions to reproducing settings indicating a reproducing source or the like of the DVD player or the like or user settings such as user 1 and user 2. Picture conditions, voice conditions, setting conditions and the like other from the input conditions are comprehensively registered in reproduction settings, whereby a variety of environments for using the DVD player (such as selection of input terminal, selections such as contrast, brightness, and picture mode of picture signal, settings of voice and/or voice quality, focus adjustment, zoom adjustment, and keystone correction caused by moving the main body) can be called and provided momentarily. Thus, after a projector for viewing a television has been used for the conventional apparatus, there is no need for a very complicated work such as resetting a variety of input conditions or setting conditions for DVD viewing, and it is possible to always provide the best performance of the reproducing apparatus by a very easy operation.

That is, DVD cinema watcher selects a component (for image quality priority such as Y/Pb/Pr or Y/Cr/Cr) for input setting; gently applies a surround effect such that a picture menu is set in a picture mode (low sepia-like color temperature), low brightness (for atmosphere of cinema), and a volume is slightly high (because an original volume is low), and sets the screen size to a 9:16 mode such that a portrait screen is displayed.

Further, a game player selects a video (general composite input) for input setting, strongly applies a surround effect such that a picture menu is set in a game mode (slightly high blue color temperature), brightness is high (because a fluorescent lamp lights), a volume is slightly low (because the original volume is high) (in order to provide the sense of spread), and sets the screen size to a 3:4 mode such that a normal screen is displayed.

As shown in the above two examples, there is provided a reproducing apparatus capable of registering all of the completely different viewing environments in user settings or reproduction settings and capable of carrying out reproducing (storing) operations during reproduction.

According to the above-described embodiments, one skilled in the art can achieve the present invention. Further, a variety of modified examples of these embodiments can be easily conceived by one skilled in the art, and it is possible to apply the invention to a variety of embodiments even if one does not have inventive ability. Therefore, the present invention covers a disclosed principle and broad range which is not contradictory to a novel feature, and is not limited to the above-described embodiments.

For example, in the above-described embodiments, although an example of a reproducing apparatus has been described as a projector apparatus, the present invention is directed to an apparatus for reproducing a picture signal, wherein a number of settings can be provided. Of course, the present invention is applied to any reproducing apparatus as long as a complicated setting work can be easily done by registering these settings and calling them during reproduction. For example, of course, the present invention can be applied to a variety of display devices such as a plasma display device and a picture information processing apparatus such as a general DVD recorder similarly, and similar operation and advantageous effect can be attained.

1. A reproducing apparatus comprising:
a plurality of input units which input a picture signal;
a reproducing unit which selects one input unit from the plurality of the input units and reproduces a picture signal from the selected input unit;
a storage unit which stores the input unit selected by the reproducing unit in association with predetermined information; and
a control unit which, when the predetermined information stored in the storage unit is specified, changes an input so as to select the one input unit in which the storage unit is stored again.

2. A reproducing apparatus according to claim 1, wherein the predetermined information is a plurality of user settings.

3. A reproducing apparatus according to claim 1, wherein the predetermined information is reproduction setting indicating a reproducing source which includes at least one of a video deck, a DVD player, a game, and a computer.

4. A reproducing apparatus according to claim 1, wherein the reproducing unit has a projector portion which causes emission light beams from a lamp unit to be transmitted at a display unit on which an image is displayed according to the picture signal, thereby externally projecting projection light beams including a picture.

5. A reproducing apparatus according to claim 1, wherein the reproducing unit selects at least one of an RGB signal, a component picture signal, an S picture signal, and a composite picture signal, and the storage unit stores the selected signal.

6. A reproducing apparatus according to claim 1, wherein the reproducing unit selects a picture signal from a SCART terminal, and the storage unit stores the selected signal.

7. A reproducing apparatus according to claim 1, wherein the reproducing unit selects a picture signal from at least a tuner unit, and the storage unit stores the selected signal.

8. A reproducing apparatus according to claim 1, wherein the storage unit stores a picture condition in association with the predetermined information, and the reproducing unit adjusts at least one of a contract of the picture signal, brightness, a picture mode, a color density, and a color hue according to the picture condition stored in the storage unit, and reproduces one of the picture signals.

9. A reproducing apparatus according to claim 1, wherein the storage unit stores a picture condition in association with the predetermined information, and the reproducing unit identifies that the picture signal is a 4:3 signal, a squeeze signal, a letterbox signal, and a cinema signal, specifies at least one of a full screen, a super live screen, a 4:3 screen, and a zoom screen according to the picture condition, and reproduces the picture signal after converting the picture.

10. A reproducing apparatus according to claim 1, wherein the storage unit stores a voice condition in association with the predetermined information, and the reproducing unit adjusts a voice signal of the picture signals to a volume according to the voice condition, and reproduces one of the provided picture signals.

11. A reproducing apparatus according to claim 1, wherein the storage unit stores a voice condition in association with the predetermined information, and the reproducing unit adjusts a voice signal of the picture signals to a sound quality according to the voice condition, and reproduces one of the provided picture signals.

12. A reproducing apparatus according to claim 1, wherein the storage unit stores an initial condition in association with the predetermined information, and the reproducing unit has a projector portion which displays an image on a display unit according to the picture signal and transmits emission light beams from a lamp unit through the displayed image, thereby externally projecting projection light beams including a picture, and, at this time, when the projected light beams from the projector portion is displayed on the display unit such as a screen, keystone correction according to the initial condition is applied to the picture signal so as to form a rectangle, and then, reproduction is carried out.

13. A reproducing apparatus according to claim 1, wherein the storage unit stores an initial condition in association with the predetermined information, and the reproducing unit carries out reproduction after correction processing has been applied to the picture signal so as to obtain an image size according to the initial condition.

14. A reproducing apparatus according to claim 1, wherein the storage unit stores an initial condition in association with the predetermined information, and the reproducing unit has a projector portion which displays an image on a display unit according to the picture signal and transmits emission light beams from a lamp unit through the displayed image, thereby externally projecting projection light beams including a picture, and, at this time, in a positional relationship between the projector portion and the display unit such as a screen, at least one of a front face, a rear face, a ceiling suspension location, and a base placement location is selected according to the initial condition, the picture signal is converted according to the selected method, and reproduction is carried out.

15. A reproducing apparatus according claim 1, wherein the predetermined information stored in the storage unit can be selected corresponding to a plurality of keys at an operating unit provided at a main body of the reproducing apparatus or a plurality of keys provided at a remote controller on a one to one basis.

16. A reproducing apparatus according claim 1, wherein the predetermined information stored in the storage unit is registered by associating a predetermined icon therewith.

17. A reproducing method comprising:
selecting one input unit from a plurality of input units which input a picture signal and reproduces a picture signal from the selected input unit;
storing the selected input unit in association with predetermined information; and
when the predetermined information is specified, changing an input so as to select the stored input unit again.

18. A reproducing method according to claim 17, further comprising:
storing that at least one of an RGB signal, a component picture signal, an S picture signal, and a composite picture signal has been selected.

19. A reproducing method according to claim 17, further comprising:
storing a picture condition in association with the predetermined information, and further, adjusting at least one of a contrast of the picture signal, brightness, a picture mode, a color density, and a color hue according to the picture condition, followed by reproduction.

20. A reproducing method according to claim 17, further comprising:
storing a voice condition in association with the predetermined information, and adjusting a voice signal caused by the picture signal to a volume according to the voice condition, followed by reproducing the picture signal and voice signal.

21. A reproducing apparatus comprising:
a plurality of input units which input a picture signal;
a reproducing unit which selects one input unit from the plurality of input units and reproduces a picture signal from the selected input unit;
a storage unit which stores that the one input unit has been selected by the reproducing unit as a user setting; and
a control unit which, when the user setting of the storage unit is specified, changes an input so as to select the one input unit stored in the storage unit again.

22. A reproducing apparatus comprising:
a plurality of input units which input a picture signal;
a reproducing unit which selects one input unit from the plurality of input units and reproduces a picture signal from the selected input unit;
a storage unit which, when the one input unit has been selected by the reproducing unit, stores another setting condition as a user setting; and
a control unit which, when the user setting of the storage unit is specified, changes an input in order to select the one input unit stored in the storage unit again, and makes a change in order to reproduce another setting condition stored in the storage unit.
